(19) United States
(12) Patent Application Publication
(10) Pub. No.: US 2026/0217271 A1
(43) Pub. Date: Jul. 30, 2026

(54) Parking Assistance Method and Parking Assistance Device

(71) Applicant: Nissan Motor Co., Ltd., Yokohama-shi, Kanagawa (JP)

(72) Inventors: Yusuke Musha, Kanagawa (JP); Yasuhiro Suzuki, Kanagawa (JP)

(21) Appl. No.: 19/148,956

(22) PCT Filed: Jan. 27, 2023
(86) PCT No.: PCT/JP2023/002587

§ 371 Date: Jul. 17, 2025

(51) Int. Cl. B60W 50/14

(52) U.S. Cl. CPC B60W 50/14; B60W 2050/146; B60W 2554/20

(57) ABSTRACT

A parking assistance method for assisting parking of an own vehicle at a target parking position, in a case where no parking position candidate existing in surroundings of the own vehicle and serving as a candidate of the target parking position can be detected, displays, when a factor preventing detection of the parking position candidate is an environmental factor, the environmental factor being a factor dependent on an environment of the own vehicle, the environmental factor on a display device and, when a factor preventing detection of the parking position candidate is a user factor, the user factor being a factor dependent on a user, the user factor on the display device.

### TECHNICAL FIELD

The present invention relates to a parking assistance method and a parking assistance device.

### BACKGROUND

In JP 2021-095113 A described below, outputting an alarm when during autonomous parking of a vehicle using a parking assistance system, the vehicle is determined to be in a state prohibiting the parking operation is described.

### SUMMARY

In the case of the parking assistance system in PTL 1 described above, there has been a risk that when no target parking position at which an own vehicle is to be parked can be detected, a user cannot understand a factor preventing detection of the target parking position and cannot cope with a situation in which no target parking position can be detected.

An object of the present invention is to facilitate, in parking assistance assisting parking of an own vehicle at a target parking position, a user to cope with a situation in which no target parking position can be detected.

### Solution to Problem

According to one aspect of the present invention, a parking assistance method for assisting parking of an own vehicle at a target parking position is provided. The parking assistance method, in a case where no parking position candidate existing in surroundings of the own vehicle and serving as a candidate of the target parking position can be detected, displays, when a factor preventing detection of the parking position candidate is an environmental factor, the environmental factor being a factor dependent on an environment of the own vehicle, the environmental factor on a display device and, when a factor preventing detection of the parking position candidate is a user factor, the user factor being a factor dependent on a user, the user factor on the display device.

The present invention facilitates, in parking assistance assisting parking of an own vehicle at a target parking position, a user to cope with a situation in which no target parking position can be detected.

### BRIEF DESCRIPTION OF THE DRAWINGS

FIG. 1 is a diagram illustrative of a schematic configuration example of a parking assistance device of embodiments;

FIGS. 2A and 2B are schematic diagrams descriptive of parking assistance control in a first assistance mode;

FIG. 3 is a schematic diagram descriptive of parking assistance control in a second assistance mode;

FIG. 4 is a schematic diagram of an example of a detection success screen;

FIG. 5 is a schematic diagram of an example of a first help screen;

FIG. 6 is a schematic diagram of an example of a second help screen;

FIG. 7 is a flowchart of a driving assistance method of a first embodiment;

FIG. 8 is a block diagram of an example of a functional configuration of a controller in FIG. 1;

FIG. 9 is a schematic diagram of an example of a search screen;

FIG. 10 is a schematic diagram of an example of a detection failure screen;

FIGS. 11A and 11B are explanatory diagrams of an example of a user factor in the first assistance mode; and

FIG. 12 is a flowchart of a driving assistance method of a second embodiment.

### DETAILED DESCRIPTION

### First Embodiment

### (Configuration)

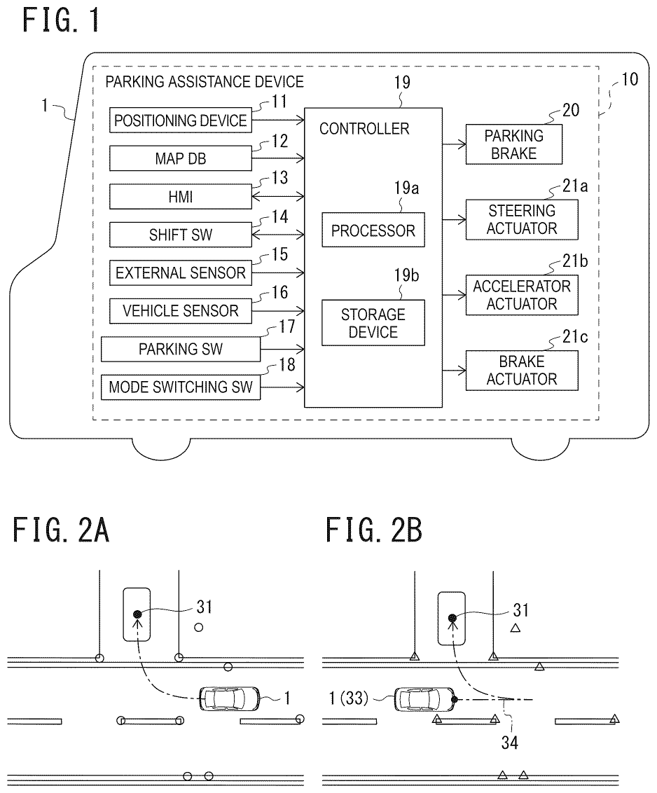

FIG. 1 is a diagram illustrative of a schematic configuration example of a parking assistance device of embodiments. An own vehicle 1 includes a parking assistance device 10 configured to assist parking of the own vehicle 1 at a target parking position. The parking assistance device 10 assists the own vehicle 1 in traveling along a target parking route from a current position of the own vehicle 1 to the target parking position. For example, the parking assistance device 10 may perform autonomous driving to control the own vehicle 1 to travel to the target parking position along the target parking route of the own vehicle 1. The autonomous driving to control the own vehicle 1 to travel to the target parking position along the target parking route means control to automatically perform all or a portion of travel along the target parking route of the own vehicle 1 by controlling all or some of a steering angle, driving force, and braking force of the own vehicle 1. Alternatively, the parking assistance device 10 may assist a user on board the own vehicle 1 (for example, a passenger such as a driver) in parking the own vehicle 1 by displaying the target parking route and the current position of the own vehicle 1 on a display device that the user can visually recognize.

A positioning device 11 measures the current position of the own vehicle 1. The positioning device 11 includes, for example, a global navigation satellite system (GNSS) receiver. In a map database (map DB) 12, map data are stored. The map data stored in the map database 12 may be, for example, map data for navigation or high-definition map data that is suitable as a map for autonomous driving.

Human-machine interfaces (HMIs) 13 are interface devices that transfer information between the parking assistance device 10 and the user. For example, the HMIs 13 may include a display device that the user can visually recognize, as an interface presenting visual information to the user. In addition, the HMIs 13 may include a speaker or a buzzer as an interface presenting auditory information to the user. In addition, the HMIs 13 may include an interface (such as a touch panel, a button, a switch, a lever, a dial, and a keyboard) accepting an operation input from the user.

A shift switch (shift SW) 14 is a switch for the driver or the parking assistance device 10 to switch a shift position of the own vehicle 1.

External sensors 15 detect an object existing in a predetermined distance range from the own vehicle 1. The external sensors 15 detect a surrounding environment of the own vehicle 1, such as a relative position between an object existing in surroundings of the own vehicle 1 and the own vehicle 1, distance between the own vehicle 1 and the object, and a direction in which the object exists. The external sensors 15 may include, for example, a camera to capture an image depicting the surrounding environment of the own vehicle 1. The external sensors 15 may include a ranging device, such as a laser range finder, a radar, a light detection and ranging (LiDAR), and a sonar. Vehicle sensors 16 detect various information (vehicle information) about the own vehicle 1. For example, the vehicle sensors 16 may include a vehicle speed sensor to detect traveling speed of the own vehicle 1, a triaxial acceleration sensor to detect acceleration (including deceleration) in three axial directions of the own vehicle 1, and a sensor to detect a steering angle of a steering wheel or a steered angle of steered wheels.

A parking switch (parking SW) 17 is a switch to start parking assistance control performed by the parking assistance device 10.

A mode switching switch (mode switching SW) 18 is a switch to switch control modes of the parking assistance control performed by the parking assistance device 10.

A controller 19 is an electronic control unit that performs parking assistance control of the own vehicle 1. The controller 19 includes a processor 19a and a peripheral component, such as a storage device 19b. The processor 19a may be, for example, a CPU or an MPU. The storage device 19b may include a semiconductor storage device, a magnetic storage device, an optical storage device, or the like. Functions of the controller 19, which will be described below, are achieved by, for example, the processor 19a executing computer programs stored in the storage device 19b.

A parking brake 20 generates friction braking force on wheels of the own vehicle 1 in accordance with operation by the user or a control signal from the controller 19.

A steering actuator 21a controls steering direction and the amount of steering of a steering mechanism of the own vehicle 1 in accordance with a control signal from the controller 19. An accelerator actuator 21b controls accelerator opening of a drive device, which is an engine or a drive motor, in accordance with a control signal from the controller 19. A brake actuator 21c causes a braking device to operate in accordance with a control signal from the controller 19.

Next, the parking assistance control performed by the controller 19 will be described. The controller 19 may execute parking assistance control to assist parking by detecting a parking position candidate present in the surroundings of the own vehicle 1 and setting the detected parking position candidate as a target parking position.

For example, the controller 19 may detect a parking position candidate present in the surroundings of own vehicle 1 from among target parking positions registered in the storage device 19b in advance. In the following description, a control mode of the parking assistance control assisting parking by detecting a parking position candidate from among target parking positions registered in advance is sometimes referred to as “first assistance mode”.

In addition, for example, the controller 19 may detect an empty space, such as a parking slot, where the own vehicle 1 can be parked in the surroundings of the own vehicle 1 as a parking position candidate without using a target parking position registered in advance. In the following description, a control mode of the parking assistance control assisting parking by detecting an empty space in the surroundings of the own vehicle 1 as a parking position candidate without using a target parking position registered in advance is sometimes referred to as “second assistance mode”.

FIGS. 2A and 2B are schematic diagrams descriptive of the parking assistance control in the first assistance mode. When the parking assistance control in the first assistance mode is used, a target parking position 31 at which the own vehicle 1 is to be parked is registered in a parking assistance device 10 in advance. Specifically, a target object existing in surroundings of the target parking position 31 is extracted and stored (registered) in the storage device 19b in advance. In the following description, a target object in the surroundings of the target parking position 31 to be stored in the storage device 19b is referred to as “learned target object”. In FIG. 2A, circular marks schematically represent learned target objects. When the target parking position 31 is to be registered in the parking assistance device 10, the user, for example, performs an operation to instruct registration of the target parking position 31 (hereinafter, sometimes referred to as “registration operation”).

For example, the controller 19 detects a target object in the surroundings of the own vehicle 1 by the external sensors 15 and stores the detected target object as a learned target object when the own vehicle 1 is positioned in a vicinity of the target parking position 31 (for example, when the user parks the own vehicle 1 at the target parking position 31 by manual driving). For example, the controller 19 may detect a target object from a surrounding image that is obtained by capturing the surroundings of the own vehicle 1 by the camera. For example, the controller 19 may detect, as a target object, an edge point where luminance changes between adjacent pixels by a predetermined amount or more or a point having a characteristic shape (a feature point), such as an edge or a corner of a target object like a pavement marking, a road boundary, an obstacle, or the like, in the captured image obtained by capturing the surroundings by the camera.

The controller 19 stores learned target object data relating to a learned target object in the storage device 19b. For example, the learned target object data may include data representing a feature amount of a learned target object (hereinafter, referred to as “feature amount data”) and data representing a relative positional relationship between the target parking position 31 and the learned target object (hereinafter, referred to as “relative position data”).

As the relative position data, a relative position of a learned target object with reference to the target parking position 31 may be stored. For example, the controller 19 can acquire a position of a learned target object detected when the own vehicle 1 is parked at the target parking position 31 as a relative position of the learned target object with reference to the target parking position 31. The controller 19 may store coordinates of a learned target object and the target parking position 31 in a coordinate system with a fixed point as a reference point (hereinafter, referred to as “map coordinate system”).

FIG. 2B is an explanatory diagram of an example of processing performed when parking assistance is performed. The controller 19 starts the parking assistance control of the own vehicle 1 when a user operation instructing start of the parking assistance control of the own vehicle 1 is performed (hereinafter, sometimes referred to as “starting operation”). For example, the starting operation may be an operation of the parking switch 17 by the user. In addition, the controller 19 may automatically start the parking assistance control when the own vehicle 1 approaches the registered target parking position 31. The parking assistance control unit 10 may be able to be set to an automatic start mode in which the controller 19 automatically start the parking assistance control when the own vehicle 1 approaches the registered target parking position 31 or a manual start mode in which the controller does not automatically start the parking assistance control even when the own vehicle 1 approaches the registered target parking position 31, by switching therebetween.

When the parking assistance control is started, the controller 19 extracts a target object in the surroundings of the own vehicle 1 by the external sensors 15. In the following description, a target object in the surroundings of the own vehicle 1 that is extracted when the parking assistance is performed is referred to as “surrounding target object”. In FIG. 2B, triangular marks represent surrounding target objects. The controller 19 detects the registered target parking position 31 as a parking position candidate by matching a learned target object and a surrounding target object with each other and associating the same feature points with each other. The controller 19 calculates a relative position of the own vehicle 1 with respect to the target parking position 31, based on a relative positional relationship between a surrounding target object detected when the parking assistance is performed and the own vehicle 1 and a relative positional relationship between a learned target object associated with the surrounding target object and the target parking position 31.

For example, the controller 19 calculates a position of the target parking position 31 in a coordinate system with reference to the current position of the own vehicle 1 (hereinafter, referred to as “vehicle coordinate system”). Note that when coordinates of the learned target object and the target parking position 31 in the map coordinate system are stored in the storage device 19b, the controller 19 may convert the coordinates of the target parking position 31 in the map coordinate system to coordinates in the vehicle coordinate system, based on the position of the surrounding target object detected when the parking assistance is performed and the position of the learned target object in the map coordinate system. The controller 19 may calculate the self-position of the own vehicle 1 in the map coordinate system, based on the position of the surrounding target object detected when the parking assistance is performed and the position of the learned target object in the map coordinate system, and calculate the relative position of the own vehicle 1 with respect to the target parking position 31 from a difference between the coordinates of the own vehicle 1 and the coordinates of the target parking position 31 in the map coordinate system.

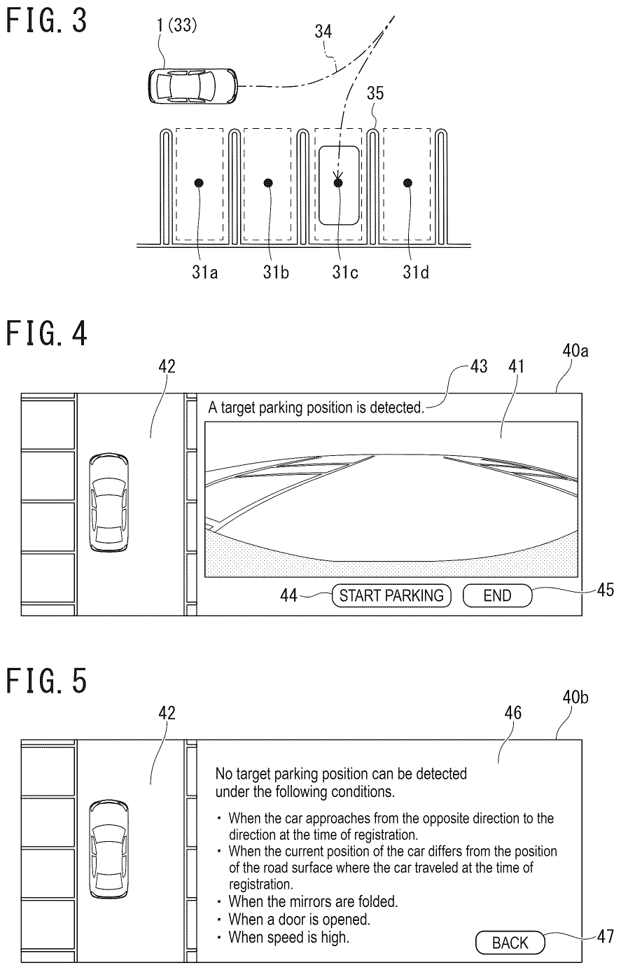

FIG. 3 is a schematic diagram descriptive of the parking assistance control in the second assistance mode. When the user performs a starting operation instructing start of the parking assistance control, the controller 19 starts the parking assistance of the own vehicle 1. When the parking assistance control in the second assistance mode is started, the controller 19 detects empty spaces 31a to 31d where the own vehicle 1 can be parked in the surroundings of the own vehicle 1 as parking position candidates, based on a detection result of the external sensors 15 detecting white lines 35 in the surroundings of the own vehicle 1 and surrounding objects around the own vehicle 1 and sets one of the empty spaces 31a to 31d as a target parking position.

For example, the controller 19 may detect an empty space where the own vehicle 1 can be parked in the surroundings of the own vehicle 1 as a parking position candidate, based on a detection result of parking slot lines 35 that indicate a parking space. In addition, for example, the controller 19 may detect parked vehicles as surrounding objects around the own vehicle 1 and detect an inter-vehicle space between the parked vehicles as a parking position candidate.

When the detection of a parking position candidate succeeds in a manner as described above, controller 19 displays a detection success screen notifying the user of success in the detection of a parking position candidate on the display device in the HMIs 13. FIG. 4 is a schematic diagram of an example of the detection success screen. For example, a detection success screen 40a includes a captured image 41 generated by capturing the surroundings of the own vehicle 1, an overhead view image 42 generated by converting captured images of the surroundings of the own vehicle 1, a message display area 43 in which a notification such as a visual message is displayed, a parking start button 44, and an end button 45.

In the message display area 43 of the detection success screen 40a, a notification, such as a visual message, that notifies the user of success in the detection of a parking position candidate is displayed. In addition, when the user operates the parking start button 44 or the end button 45 displayed on the display device, a touch panel provided on the display device detects such an operation. When the parking start button 44 is operated, the controller 19 sets the parking position candidate as a target parking position 31 and calculates a target parking route 34 starting from a current position 33 of the own vehicle 1 and reaching the target parking position 31. The controller 19 performs the parking assistance control of the own vehicle 1, based on the calculated target parking route 34.

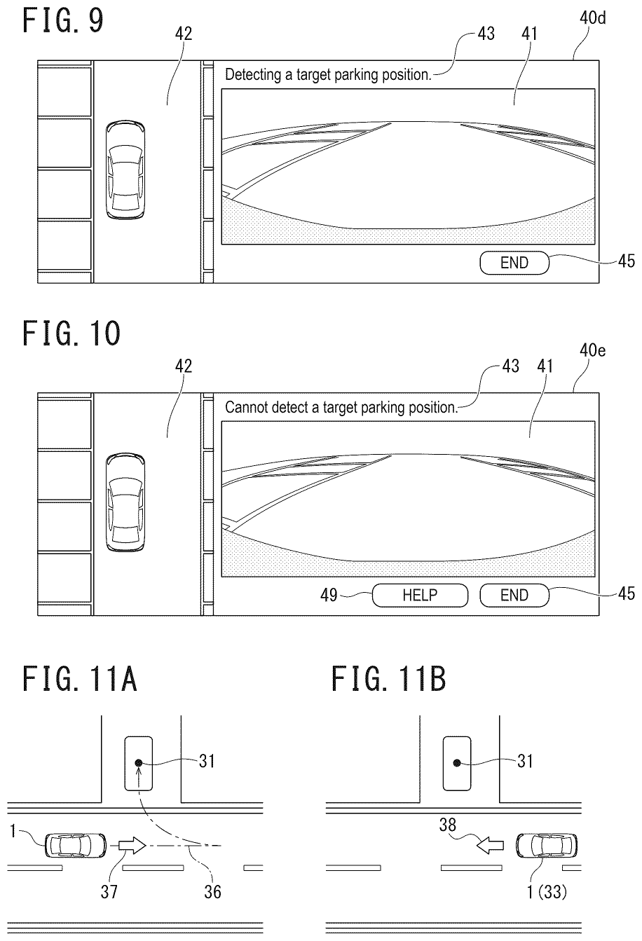

When the end button 45 is operated, the controller 19 suspends the parking assistance control. The same applies to a case where an end button 45 in each of a search screen 40d and a detection failure screen 40e, which will be described later, that are illustrated in FIGS. 9 and 10, respectively are operated.

In contrast, when no parking position candidate can be detected, the controller 19 determines whether a factor preventing detection of a parking position candidate is a user factor or an environmental factor, the user factor being a factor dependent on a user and the environmental factor being a factor dependent on an environment of the own vehicle 1.

When the factor preventing the detection of a parking position candidate is a user factor, the controller 19 displays a first help screen that informs the user of the user factor on the display device in the HMIs 13.

FIG. 5 is a schematic diagram of an example of the first help screen. For example, a first help screen 40b includes an overhead view image 42, a user factor display area 46 in which a user factor is displayed, and a back button 47. When the user operates the back button 47, the touch panel provided on the display device detects the operation and the controller 19 terminates the display of the first help screen 40b.

When the factor preventing the detection of a parking position candidate is an environmental factor, the controller 19 displays a second help screen that informs the user of the environmental factor on the display device in the HMIs 13.

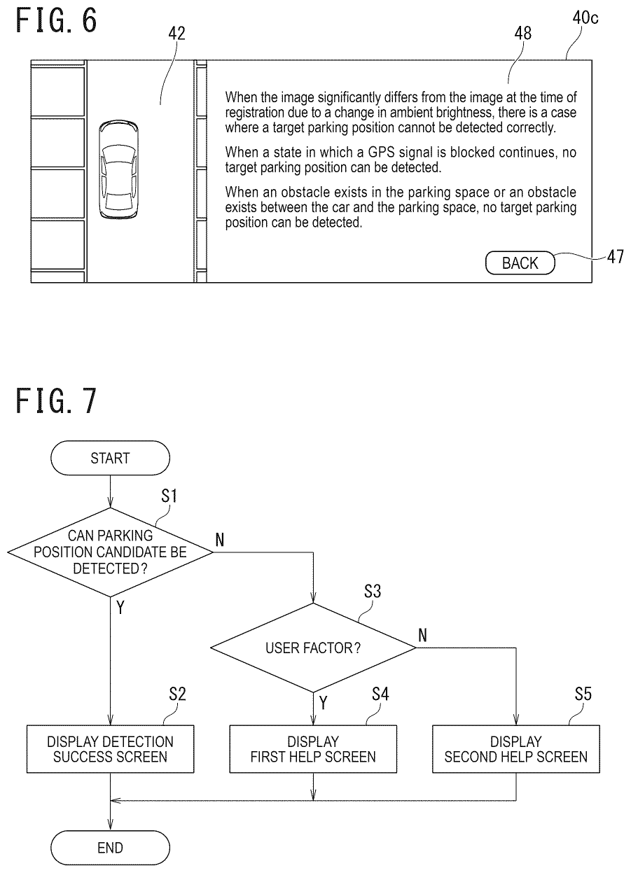

FIG. 6 is a schematic diagram of an example of the second help screen. For example, a second help screen 40c includes an overhead view image 42, an environmental factor display area 48 in which an environmental factor is displayed, and a back button 47. When the user operates the back button 47, the controller 19 terminates the display of the second help screen 40c.

### (Operation)

FIG. 7 is a flowchart of a driving assistance method of a first embodiment. In step S1, the controller 19 determines whether or not a parking position candidate can be detected. When a parking position candidate can be detected (step S1: Y), the process proceeds to step S2. When no parking position candidate can be detected (step S1: N), the process proceeds to step S3. In step S2, the controller 19 displays the detection success screen 40a on the display device. In step S3, the controller 19 determines whether or not a factor preventing the detection of a parking position candidate is a user factor. When the factor preventing the detection of a parking position candidate is a user factor (step S3: Y), the process proceeds to step S4. When the factor preventing the detection of a parking position candidate is an environmental factor (step S3: N), the process proceeds to step S5. In step S4, the controller 19 displays the first help screen 40b on the display device. In step S5, the controller 19 displays the second help screen 40c on the display device.

### Second Embodiment

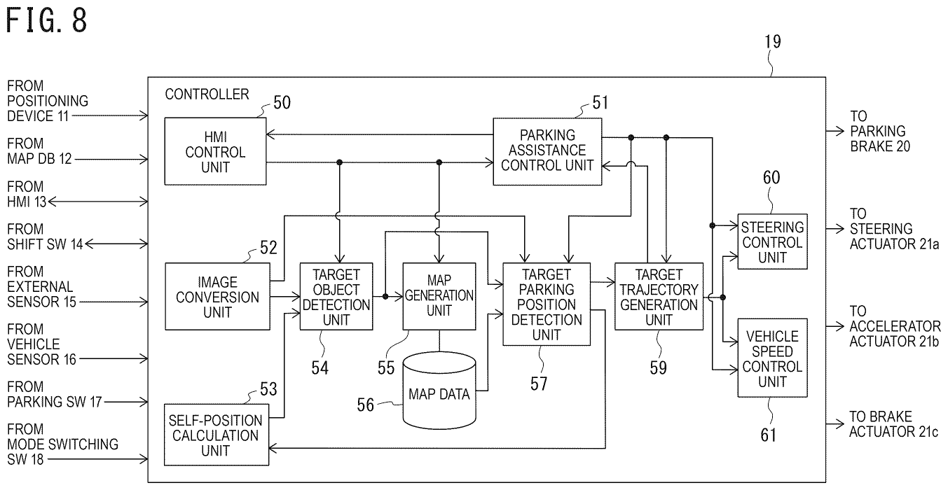

FIG. 8 is a block diagram of an example of a functional configuration of a controller 19. When an HMI control unit 50 detects a registration operation of a target parking position 31 performed by a user, the HMI control unit 50 outputs a map generation command to cause learned target object data to be stored in a storage device 19b, to a map generation unit 55. In addition, when the HMI control unit 50 detects a starting operation of parking assistance control, the starting operation being performed by the user, the HMI control unit 50 outputs a control start command to start the parking assistance control to assist parking at a target parking position, to a parking assistance control unit 51.

An image conversion unit 52 converts a captured image captured by a camera to an overhead view image that is an image viewed from a virtual viewpoint directly above an own vehicle 1. The image conversion unit 52 generates a surrounding image that is an image depicting a surrounding region of the own vehicle 1 by converting a captured image to an overhead view image at a predetermined interval and accumulating converted overhead view images along a travel route of the own vehicle 1.

A self-position calculation unit 53 calculates a current position of the own vehicle 1 in a map coordinate system as a self-position by odometry (for example, dead reckoning) based on vehicle information output from vehicle sensors 16.

A target object detection unit 54 detects a target object from a surrounding image output from the image conversion unit 52. The target object detection unit 54 may detect a position of a feature point of a target object and an image feature amount of the feature point as a target object. The target object detection unit 54 outputs the detected position and image feature amount of the feature point to the map generation unit 55 and a target parking position detection unit 57 as target object data. In addition, the target object detection unit 54 outputs the self-position acquired from the self-position calculation unit 53 in synchronization with the detection of the target object to the map generation unit 55 and the target parking position detection unit 57.

When the map generation unit 55 receives a map generation command from the HMI control unit 50 (that is, when the registration operation of the target parking position 31 is performed), the map generation unit 55 generates learned target object data and stores the generated learned target object data in the storage device 19b as map data 56. For example, the map generation unit 55 receives target object data and a self-position of the own vehicle 1 in the map coordinate system that is synchronous with the target object data from the target object detection unit 54. The map generation unit 55 acquires position information of the target parking position 31 in the map coordinate system. For example, the map generation unit 55 may acquire a self-position that the self-position calculation unit 53 calculates when the own vehicle 1 is positioned at the target parking position 31 as the position information of the target parking position 31. The map generation unit 55 generates relative position data, based on a position of a feature point included in the target object data, position information of the own vehicle 1 synchronous with the position of the feature point, and position information of the target parking position 31. The map generation unit 55 acquires feature amount data from the target object data output from the target object detection unit 54. The map generation unit 55 stores learned target object data including the above-described relative position data and feature amount data in the storage device 19b as the map data 56.

In a case where the parking assistance device 10 is set to an automatic start mode, the parking assistance control unit 51 determines whether or not a current position of the own vehicle 1 is in a vicinity of the registered target parking position 31. When the current position of the own vehicle 1 is in the vicinity of the registered target parking position 31, the parking assistance control unit 51 starts the parking assistance control and causes the parking assistance device 10 to operate in a first assistance mode. On the other hand, in a case where the parking assistance device 10 is set to a manual start mode, when the parking assistance control unit 51 receives a control start command from the HMI control unit 50, the parking assistance control unit 51 determines whether or not the current position of the own vehicle 1 is in the vicinity of the registered target parking position 31. When the current position of the own vehicle 1 is in the vicinity of the registered target parking position 31, the parking assistance control unit 51 causes the parking assistance device 10 to operate in the first assistance mode. When the current position of the own vehicle 1 is not in the vicinity of the registered target parking position 31, the parking assistance control unit 51 causes the parking assistance device 10 to operate in a second assistance mode.

When the parking assistance control unit 51 starts the parking assistance control, the parking assistance control unit 51 determines whether or not a predetermined system condition for executing the parking assistance control is satisfied. When the system condition is satisfied, the parking assistance control unit 51 outputs a parking position calculation command to the target parking position detection unit 57. When the system condition is not satisfied, the parking assistance control unit 51 does not output a parking position calculation command to the target parking position detection unit 57. Thus, the target parking position detection unit 57 does not execute detection of a parking position candidate. That is, the target parking position detection unit 57 does not determine whether or not a parking position candidate can be detected. Note that the system condition may be, for example, a condition requiring a shift position not to be in a parking range or a condition requiring the user to have fastened a seat belt.

When the target parking position detection unit 57 receives a parking position calculation command, the target parking position detection unit 57, in the case of the parking assistance control in the first assistance mode, receives target object data output from the target object detection unit 54 as target object data of a surrounding target object and also receives the self-position of the own vehicle 1 in the map coordinate system in synchronization with the reception of the target object data.

The target parking position detection unit 57 detects the registered target parking position 31 as a parking position candidate by matching a learned target object and a surrounding target object with each other and associating the same feature points with each other. That is, the target parking position detection unit 57 determines whether or not the registered target parking position 31 can be detected, based on whether or not matching between the learned target object and the surrounding target object succeeds. When the matching succeeds (that is, when the target parking position 31 is detected), the target parking position detection unit 57 calculates a relative position of the own vehicle 1 with respect to the target parking position 31, based on a relative positional relationship between a surrounding target object and the own vehicle 1 and a relative positional relationship between a learned target object associated with the surrounding target object and the target parking position 31.

In the case of the parking assistance control in the second assistance mode, the target parking position detection unit 57 determines whether or not there is a space where the own vehicle 1 can be parked in the surroundings of the own vehicle 1 (that is, determines whether or not the target parking position 31 can be detected), based on a detection result of the external sensors 15 detecting white lines in the surroundings of the own vehicle 1 or surrounding objects around the own vehicle 1 (for example, parked vehicles). The target parking position detection unit 57 detects a space where the own vehicle 1 can be parked in the surroundings of the own vehicle 1 as a parking position candidate.

The parking assistance control unit 51 sets the detected parking position candidate as the target parking position 31. A target trajectory generation unit 59 calculates a target parking route starting from the current position of the own vehicle 1 and reaching the target parking position 31 in the vehicle coordinate system. The target trajectory generation unit 59 calculates a target vehicle speed profile that is a target value of vehicle speed of the own vehicle 1 on the target parking route. A steering control unit 60 controls a steering actuator 21a in such a way that the own vehicle 1 travels along the target parking route. A vehicle speed control unit 61 controls an accelerator actuator 21b and a brake actuator 21c in such a way that the vehicle speed of the own vehicle 1 changes in accordance with the target vehicle speed profile. When the own vehicle 1 reaches the target parking position 31 and the parking assistance control is completed, the parking assistance control unit 51 causes a parking brake 20 to operate and switches the shift position to a parking range.

While the target parking position detection unit 57 is attempting the detection of a parking position candidate (that is, attempting to match a learned target object with a surrounding target object), the HMI control unit 50 displays a search screen that notifies the user that the parking assistance device 10 is attempting the detection of a parking position candidate on the display device in the HMIs 13.

FIG. 9 is a schematic diagram of an example of the search screen. For example, a search screen 40d includes a captured image 41, an overhead view image 42, a message display area 43, and an end button 45. In the message display area 43, a notification, such as a visual message, that notifies the user that the parking assistance device 10 is attempting the detection of a parking position candidate may be displayed.

In addition, when the target parking position detection unit 57 does not execute the detection of a parking position candidate since the above-described system condition (for example, the condition requiring the shift position not to be in the parking range or the condition requiring the user to have fastened a seat belt) is not satisfied, a different display (information) than a first help screen 40b or a second help screen 40c may be displayed on the display device in the HMIs 13. For example, in the message display area 43 of the search screen 40d, a notification, such as a visual message, notifying that the system condition is not satisfied (for example, the shift position is in the parking range or the user has not fastened a seat belt) may be displayed.

When the target parking position detection unit 57 detects a parking position candidate (that is, in the case of successful detection of a parking position candidate), the HMI control unit 50 displays a detection success screen 40a illustrated in FIG. 4 on the display device in the HMIs 13.

In contrast, when the target parking position detection unit 57 cannot detect a parking position candidate (that is, in the case of failed detection of a parking position candidate), the HMI control unit 50 displays a detection failure screen notifying the user that the target parking position detection unit 57 cannot detect a parking position candidate on the display device in the HMIs 13. FIG. 10 is a schematic diagram of an example of the detection failure screen. For example, a detection failure screen 40e includes a captured image 41, an overhead view image 42, a message display area 43, a help button 49, and an end button 45. In the message display area 43, a notification, such as a visual message, that notifies the user that the parking assistance device 10 cannot detect a parking position candidate may be displayed.

Note that in the case where the parking assistance device 10 is set to the automatic start mode, the HMI control unit 50 may automatically start the display of the detection success screen 40a when the parking assistance device 10 succeeds in detecting a parking position candidate. On the other hand, in the case where the parking assistance device 10 is set to the automatic start mode, the HMI control unit 50 does not have to automatically start the display of the detection failure screen 40e even when the parking assistance device 10 fails in detecting a parking position candidate. In this case, the HMI control unit 50 may start the display of the detection failure screen 40e when, for example, the user operates the parking switch 17.

When the user operates the help button 49, the HMI control unit 50 detects the operation of the help button 49 via a touch panel provided on the display device. When the help button 49 is operated, the HMI control unit 50 determines whether a factor preventing the detection of a parking position candidate is a user factor or an environmental factor. The user factor in the first assistance mode and the second assistance mode may include, for example, a factor that a side mirror is folded, a factor that a door is open, or a factor that vehicle speed is greater than or equal to a threshold value.

FIGS. 11A and 11B are explanatory diagrams of another example of the user factor in the first assistance mode. FIG. 11A illustrates a scene in which a target parking position 31 is registered in the parking assistance device 10 in advance. In this example, a case is assumed where the own vehicle 1 is caused to travel in a direction 37 indicated by an arrow and brought close to the target parking position 31. The user causes the own vehicle 1 to travel along a parking route 36 by manual driving and to be parked at the target parking position 31, and causes target objects in the surroundings of the target parking position 31 detected in this process to be stored in the storage device 19b as learned target objects.

FIG. 11B illustrates a scene in which the registered target parking position 31 is detected as a parking position candidate. In this example, a case is assumed where the own vehicle 1 is caused to travel in a direction 38 indicated by an arrow and approaches the target parking position 31.

The user factor may include a factor that the direction 38 in which, when a parking position candidate is to be detected, the own vehicle 1 approaches the parking position candidate (that is, the target parking position 31) differs from the direction 37 in which the own vehicle 1 approached the target parking position 31 when the own vehicle 1 was parked at the target parking position 31 to store the target parking position 31 in the parking assistance device 10. Specifically, the above-described factor may be determined based on a criterion that an angle formed by the direction 38 and the direction 37 is greater than or equal to a predetermined value.

In addition, the user factor in the first assistance mode may include a factor that a current position 33 of the own vehicle 1 when a parking position candidate is to be detected (FIG. 11B) is located apart from the parking route 36 when the own vehicle 1 was parked at the target parking position 31 to store the target parking position 31 in the parking assistance device 10 (FIG. 11A). Specifically, the above-described factor may be determined based on a criterion that distance between the parking route 36 and the current position 33 of the own vehicle 1 is greater than or equal to a predetermined value.

When the factor preventing the detection of a parking position candidate is a user factor, the HMI control unit 50 displays the first help screen 40b illustrated in FIG. 5 on the display device in the HMIs 13. The HMI control unit 50 may display visual messages: “When the car approaches from the opposite direction to the direction at the time of registration.”; “When the current position of the car differs from the position of the road surface where the car traveled at the time of registration.”; “When the mirrors are folded.”; “When a door is opened.”; and “When speed is high.” that notify the user of the above-described user factors (the factor that the direction 38 in which, when a parking position candidate is to be detected, the own vehicle 1 approaches the parking position candidate differs from the direction 37 when the own vehicle 1 approaches the target parking position 31 at the time of registration of the target parking position 31, the factor that the current position 33 at the time of detection of a parking position candidate is located apart from the parking route 36 when the target parking position 31 was registered, the factor that a side mirror is folded, the factor that a door is opened, and the factor that vehicle speed is greater than or equal to a threshold value), respectively, in the user factor display area 46 of the first help screen 40b.

The environmental factor in the first assistance mode and the second assistance mode may include, for example, inability to detect a parking position candidate due to an obstacle. The reason for the inability to detect a parking position candidate due to an obstacle in the first assistance mode may include, for example, existence of an obstacle at the registered target parking position 31 or existence of an obstacle on a route from the current position of the own vehicle 1 to the registered target parking position 31. In addition, for example, the reason for the inability to detect a parking position candidate due to an obstacle in the second assistance mode may include existence of an obstacle at a space where the own vehicle 1 can be parked in the surroundings of the own vehicle 1 or existence of an obstacle on a route from the current position of the own vehicle 1 to a space where the own vehicle 1 can be parked.

The environmental factor in the first assistance mode may include, for example, inability to measure the current position of the own vehicle 1 by the positioning device 11 at the time of detection of a parking position candidate. The environmental factor in the first assistance mode may be, for example, inability to detect a parking position candidate due to a difference between an image from which a target object existing in the surroundings of the target parking position 31 was detected at the time of storing the learned target object data in the storage device 19b (that is, at the time of registering the target parking position 31) and an image from which a surrounding target object is detected at the time of detection of a parking position candidate.

When the factor preventing the detection of a parking position candidate is an environmental factor, the HMI control unit 50 displays the second help screen 40c illustrated in FIG. 6 on the display device in the HMIs 13. The HMI control unit 50 may display visual messages: “When an obstacle exists in the parking space or an obstacle exists between the car and the parking space, no target parking position can be detected.”; “When a state in which a GPS signal is blocked continues, no target parking position can be detected.”; and “When the image significantly differs from the image at the time of registration due to a change in ambient brightness, there is a case where a target parking position cannot be detected correctly.” that notify the user of the above-described environmental factors (the inability to detect a parking position candidate due to an obstacle, the inability to measure the current position of the own vehicle 1, and the inability to detect a parking position candidate due to a difference between the image from which a target object was detected at the time of registering the target parking position 31 and the image from which a target object is detected at the time of detection of a parking position candidate), respectively, in the environmental factor display area 48 of the first help screen 40b.

Note that when a user factor and an environmental factor are simultaneously present, the HMI control unit 50 may preferentially display one of the user factor and the environmental factor. For example, when the help button 49 is operated, the HMI control unit 50 may preferentially display one of the first help screen 40b and the second help screen 40c.

While a user factor is a factor that is comparatively easy for a user to eliminate, eliminating an environmental factor involves difficulty for user in many cases. Thus, when a user factor and an environmental factor are simultaneously present, the HMI control unit 50 may, for example, display the environmental factor preferentially over the user factor.

On the contrary, the HMI control unit 50 may display the user factor preferentially over the environmental factor. When a user factor and an environmental factor are simultaneously present, the HMI control unit 50 may display both the user factor and the environmental factor.

Note that, in the case of the parking assistance control in the second assistance mode, the HMI control unit 50 does not have to display the first help screen 40b or the second help screen 40c. In this case, for example, the HMI control unit 50 may stop display of the help button 49 in the detection failure screen 40e or disable the help button 49. The HMI control unit 50 may display a user factor or an environmental factor in the message display area 43 of the detection failure screen 40e.

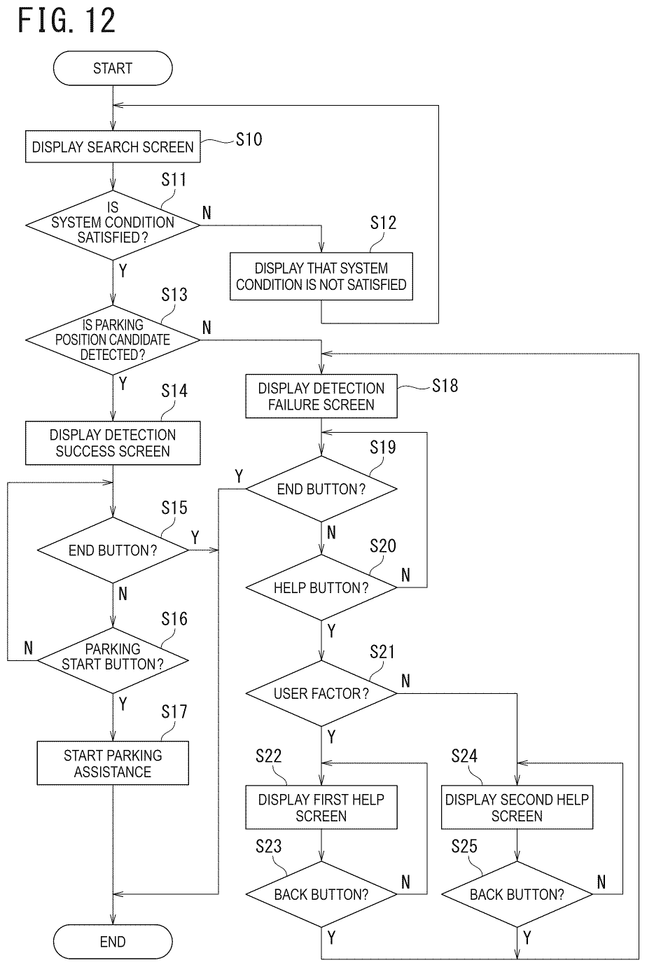

FIG. 12 is a flowchart of a driving assistance method of a second embodiment.

When the parking assistance control is started, the HMI control unit 50 displays the search screen 40d in step S10. In step S11, the parking assistance control unit 51 determines whether or not the system condition is satisfied. When the system condition is satisfied (step S11: Y), the process proceeds to step S13. When the system condition is not satisfied (step S11: N), the process proceeds to step S12. In step S12, the HMI control unit 50 displays a message indicating that the system condition is not satisfied on the search screen 40d. Subsequently, the process returns to step S11. In step S13, the target parking position detection unit 57 determines whether or not a parking position candidate can be detected. When a parking position candidate can be detected (step S13: Y), the process proceeds to step S14. When no parking position candidate can be detected (step S13: N), the process proceeds to step S18. In step S14, the HMI control unit 50 displays the detection success screen 40a.

In step S15, the HMI control unit 50 determines whether or not the end button 45 has been operated. When the end button 45 is operated (step S15: Y), the process terminates. When the end button 45 has not been operated (step S15: N), the process proceeds to step S16.

In step S16, the HMI control unit 50 determines whether or not the parking start button 44 has been operated. When the parking start button 44 has not been operated (step S16: N), the process returns to step S15. When the parking start button 44 is operated (step S16: Y), the process proceeds to step S17. In step S17, the parking assistance control unit 51 sets a detected parking position candidate as a target parking position 31. The target trajectory generation unit 59 calculates a target parking route starting from a current position 33 of the own vehicle 1 and reaching the target parking position 31. The steering control unit 60 and the vehicle speed control unit 61 perform the parking assistance control of the own vehicle 1, based on a calculated target parking route 34. Subsequently, the process terminates.

In step S18, the HMI control unit 50 displays the detection failure screen 40e. In step S19, the HMI control unit 50 determines whether or not the end button 45 has been operated. When the end button 45 is operated (step S19: Y), the process terminates. When the end button 45 has not been operated (step S19: N), the process proceeds to step S20.

In step S20, the HMI control unit 50 determines whether or not the help button 49 has been operated. When the help button 49 has not been operated (step S20: N), the process returns to step S19. When the help button 49 is operated (step S20: Y), the process proceeds to step S21.

In step S21, the HMI control unit 50 determines whether a factor preventing detection of a parking position candidate is a user factor or an environmental factor. When the factor preventing the detection of a parking position candidate is a user factor (step S21: Y), the process proceeds to step S22. When the factor preventing the detection of a parking position candidate is an environmental factor (step S21: N), the process proceeds to step S24.

In step S22, the HMI control unit 50 displays the first help screen 40b. In step S23, the HMI control unit 50 determines whether or not the back button 47 has been operated. When the back button 47 has not been operated (step S23: N), the process returns to step S22. When the back button 47 is operated (step S23: Y), the process returns to step S18.

In step S24, the HMI control unit 50 displays the second help screen 40c. In step S25, the HMI control unit 50 determines whether or not the back button 47 has been operated. When the back button 47 has not been operated (step S25: N), the process proceeds to step S24. When the back button 47 is operated (step S25: Y), the process returns to step S18.

In step S18, the HMI control unit 50 displays the detection failure screen 40e. When in step S19, the end button 45 is operated (step S19: Y), the process terminates.

### Advantageous Effects of Embodiments

(1) A controller 19 assists parking of an own vehicle 1 at a target parking position. The controller 19, in a case where no parking position candidate existing in surroundings of the own vehicle 1 and serving as a candidate of the target parking position can be detected, displays, when a factor preventing detection of the parking position candidate is an environmental factor, the environmental factor being a factor dependent on an environment of the own vehicle 1, the environmental factor on a display device and, when a factor preventing detection of the parking position candidate is a user factor, the user factor being a factor dependent on a user, the user factor on the display device. This configuration facilitates, when no target parking position can be detected, a user to cope with a situation in which no target parking position can be detected.
(2) The controller 19 may determine whether or not a predetermined system condition for executing parking assistance control is satisfied and, when the system condition is satisfied, perform detection of the parking position candidate and, when the system condition is not satisfied, display a display different from a display of the environmental factor and a display of the user factor on the display device. Because of this configuration, it is possible to, when the system condition is not satisfied, omit detection processing of the target parking position and notify the user that the system condition is not satisfied.
(3) In driving assistance control in a first assistance mode, the controller 19 may: store data representing a relative positional relationship between a target object existing in surroundings of a target parking position and a target parking position in a storage device as learned target object data in advance; detect a surrounding target object, the surrounding target object being a target object existing in surroundings of the own vehicle 1; and detect the parking position candidate existing in surroundings of the own vehicle 1, based on the learned target object data of a target object existing in surroundings of the own vehicle 1 and the surrounding target object. Because of this configuration, a user can use parking assistance control assisting parking of the own vehicle 1 at a target parking position registered in advance.
(4) In the driving assistance control in the first assistance mode, the controller 19 may detect, when a current position of the own vehicle 1 can be measured at a time of detecting the parking position candidate stored in advance, a target object existing in surroundings of the current position as the surrounding target object. The environmental factor may include inability to measure a current position of the own vehicle 1. Because of this configuration, it is possible to notify the user of inability to detect the target parking position due to inability to measure the current position of the own vehicle 1.
(5) In the driving assistance control in the first assistance mode, the user factor may include a factor that a first direction, the first direction being a direction in which the own vehicle 1 approaches the parking position candidate at a time of detecting the parking position candidate stored in advance, differs from a second direction, the second direction being a direction in which the own vehicle 1 approaches the target parking position when the own vehicle 1 is parked at the target parking position to store the learned target object data in the storage device. Because of this configuration, it is possible to notify the user of inability to detect the target parking position due to a difference in directions in which the own vehicle 1 approaches the target parking position between when a target parking position is registered and when the registered target parking position is detected.
(6) In the driving assistance control in the first assistance mode, the controller 19 may measure a current position of the own vehicle 1 at a time of detecting the parking position candidate stored in advance. The user factor may include a factor that the measured current position is located a predetermined distance or more apart from a parking route along which the own vehicle 1 travels to the target parking position when the own vehicle 1 is parked at the target parking position to store the learned target object data in the storage device. Because of this configuration, it is possible to notify the user of inability to detect the target parking position due to the current position of the own vehicle 1 being located apart from the parking route at the time of registration of the target parking position.
(7) The environmental factor may include inability to detect the target parking position due to a difference between an image from which a target object existing in surroundings of the target parking position is detected at a time of storing the learned target object data in the storage device and an image from which the surrounding target object is detected. Because of this configuration, it is possible to notify the user of inability to detect the target parking position due to a significant difference in images from which a target object is detected between when a target parking position is registered and when the registered target parking position is detected.
(8) In the driving assistance control in a second assistance mode, the controller 19 may detect an empty space where the own vehicle 1 can be parked in surroundings of the own vehicle 1 as a target parking position, based on a detection result of a sensor detecting a white line or an object in surroundings of the own vehicle 1. Because of this configuration, the user can use parking assistance control assisting parking of the own vehicle 1 at a target parking position not registered in advance.
(9) The environmental factor may include inability to detect the target parking position due to an obstacle. Because of this configuration, it is possible to notify the user of inability to detect the target parking position due to an obstacle.
(10) When the environmental factor and the user factor are simultaneously present, the controller 19 may display one of the environmental factor and the user factor and does not have to display the other. Because of this configuration, it is possible to determine which of the environmental factor and the user factor is to be informed to the user in a preferential manner depending on characteristics of a factor preventing the detection of the target parking position.

For example, the controller 19 may display the environmental factor and does not have to display the user factor. Because of this configuration, the environmental factor that is difficult for the user to eliminate can be preferentially notified.

### REFERENCE SIGNS LIST

1 Own vehicle
10 Parking assistance device
19 Controller

1. A parking assistance method for assisting parking of an own vehicle at a target parking position, the parking assistance method comprising:
storing data representing a relative positional relationship between a target object existing in surroundings of a target parking position and a target parking position in a storage device as learned target object data in advance;
detecting a surrounding target object, the surrounding target object being a target object existing in surroundings of the own vehicle;
detecting a parking position candidate existing in surroundings of the own vehicle and serving as a candidate of the target parking position, based on the learned target object data of a target object existing in surroundings of the own vehicle and the surrounding target object; and
in a case where no parking position candidate existing in surroundings of the own vehicle can be detected, displaying, when a factor preventing detection of the parking position candidate is an environmental factor, the environmental factor being a factor dependent on an environment of the own vehicle, the environmental factor on a display device and, when a factor preventing detection of the parking position candidate is a user factor, the user factor being a factor dependent on a user, the user factor on the display device.

2. The parking assistance method according to claim 1 comprising:
determining whether or not a predetermined system condition for executing parking assistance control, the parking assistance control assisting parking of the own vehicle at the target parking position, is satisfied; and
when the system condition is satisfied, performing detection of the parking position candidate and, when the system condition is not satisfied, displaying a display different from a display of the environmental factor and a display of the user factor on the display device.

3. (canceled)

4. The parking assistance method according to claim 1, wherein
when a current position of the own vehicle can be measured at a time of detecting the parking position candidate stored in advance, the parking assistance method detects a target object existing in surroundings of the current position as the surrounding target object, and
the environmental factor includes inability to measure a current position of the own vehicle.

5. The parking assistance method according to claim 1, wherein the user factor includes a factor that a first direction, the first direction being a direction in which the own vehicle approaches the parking position candidate at a time of detecting the parking position candidate stored in advance, differs from a second direction, the second direction being a direction in which the own vehicle approaches the target parking position when the own vehicle is parked at the target parking position to store the learned target object data in the storage device.

6. The parking assistance method according to claim 1, wherein
the parking assistance method measures a current position of the own vehicle at a time of detecting the parking position candidate stored in advance, and
the user factor includes a factor that the measured current position is located a predetermined distance or more apart from a parking route along which the own vehicle travels to the target parking position when the own vehicle is parked at the target parking position to store the learned target object data in the storage device.

7. The parking assistance method according to claim 1, wherein the environmental factor includes inability to detect the target parking position due to a difference between an image from which a target object existing in surroundings of the target parking position is detected at a time of storing the learned target object data in the storage device and an image from which the surrounding target object is detected.

8. The parking assistance method according to claim 1, wherein the parking assistance method detects an empty space where the own vehicle can be parked in surroundings of the own vehicle as the target parking position, based on a detection result of a sensor detecting a white line or an object in surroundings of the own vehicle.

9. The parking assistance method according to claim 1, wherein the environmental factor includes inability to detect the target parking position due to an obstacle.

10. The parking assistance method according to claim 1, wherein when the environmental factor and the user factor are simultaneously present, the parking assistance method displays one of the environmental factor and the user factor and does not display another.

11. The parking assistance method according to claim 10, wherein the parking assistance method displays the environmental factor and does not display the user factor.

12. A parking assistance device configured to assist parking of an own vehicle at a target parking position, the parking assistance device comprising:
a storage device;
a display device; and
a controller configured to:
store data representing a relative positional relationship between a target object existing in surroundings of a target parking position and a target parking position in a storage device as learned target object data in advance;
detect a surrounding target object, the surrounding target object being a target object existing in surroundings of the own vehicle;
detect a parking position candidate existing in surroundings of the own vehicle and serving as a candidate of the target parking position, based on the learned target object data of a target object existing in surroundings of the own vehicle and the surrounding target object; and
in a case where no parking position candidate existing in surroundings of the own vehicle can be detected, display, when a factor preventing detection of the parking position candidate is an environmental factor, the environmental factor being a factor dependent on an environment of the own vehicle, the environmental factor on the display device and, when a factor preventing detection of the parking position candidate is a user factor, the user factor being a factor dependent on a user, the user factor on the display device.
